(19) United States
(12) Patent Application Publication
(10) Pub. No.: US 2004/0040036 A1
(43) Pub. Date: Feb. 26, 2004

(54) Apparatus and method of converting electronic program guide information into XML

(75) Inventor: Cheol-hong An, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/425,983

(22) Filed: Apr. 30, 2003

(30) Foreign Application Priority Data
Aug. 22, 2002 (KR) 2002-49703

(51) Int. Cl. G06F 3/00; H04N 5/445; G06F 13/00; H04N 7/01; H04N 11/20

(52) U.S. Cl. 725/39; 715/513

(57) ABSTRACT

An apparatus and method of converting electronic program guide (EPG) information into an extensible markup language (XML) format. According to the apparatus and method, it is possible to extract EPG information from a data stream, convert the extracted EPG information into an XML format, and display the EPG information designated as displayable in the XML format and to transmit the EPG information in the XML format to an external device via a network.

### CROSS-REFERENCE TO RELATED APPLICATIONS

This application claims the benefit of Korean Application No. 2002-49703 filed Aug. 22, 2002, in the Korean Intellectual Property Office, the disclosure of which is incorporated herein by reference.

### BACKGROUND OF THE INVENTION

1. Field of the Invention

The present invention relates to an apparatus and method of easily detecting and receiving a program televised in a digital TV, and more particularly, to an apparatus and method of converting electronic program guide (EPG) information into extensible markup language (XML).

2. Description of the Related Art

A digital TV (DTV) broadcasting system, in which a television signal is converted into a digital signal and transmitted to a receiving end (receiving device), for example, to a television in each household via a communication satellite (CS), has come into wide use. The DTV broadcasting system can hold 150 or more channels and can broadcast more programs than the existing ground wave broadcasting systems.

The DTV broadcasting system transmits electronic program guide (EPG) information to a receiving end so that a televiewer can select a desired program based on the received EPG information. In general, the EPG information is transmitted in the form of a program information table in a DTV broadcasting system, whereas it is transmitted as program and service information protocols (PSIPs) in the case of a ground-wave broadcasting system and transmitted as service information (SI) in the case of cable/satellite broadcasting systems. Whenever a user at a receiving end requests for the EPG information to be displayed, the DTV broadcasting system receives the program information table and displays the EPG information contained in the table on a TV screen. The EPG information contains broadcast schedule information, such as the name of a program, a broadcast channel number, a program genre, the starting and closing time of a broadcast, and the contents of a program. The information stored in the table is useful in establishing an EPG navigation graphic interface. However, although data of the EPG information is standardized, there are no standards specifying what information to display. For this reason, from the same EPG information different information is displayed according to the maker or the kind/type of a receiving device.

Therefore, the EPG information display format can be unpredictable or unnecessarily vary by depending on a manufacturer of a receiving device, and lack of an EPG content display standard can further increase the number of processes required in developing the software to display the EPG information results (i.e., increase software development time).

### SUMMARY OF THE INVENTION

The present invention provides an apparatus and method of standardizing EPG information exchange (i.e., supply or interchange of EPG information among receiving devices, such as what EPG information is provided to a user) by uniformly specifying/describing the EPG information. More particularly, the present invention provides an effective analysis of the electronic program guide (EPG) information exchanged between network devices by analyzing the EPG information and converting important information contained in the EPG information into extensible markup language (XML).

Additional aspects and advantages of the invention will be set forth in part in the description which follows and, in part, will be obvious from the description, or may be learned by practice of the invention.

The present invention provides an electronic program guide (EPG) information converter comprising an EPG extractor extracting EPG information from a data stream; an EPG parser parsing the extracted EPG information; an extensible markup language (XML) converter converting the parsed EPG information into an XML format; an internal EPG presentation unit presenting program information to a user in response to the EPG information in the XML format; and an XML data transmitter transmitting the EPG information in the XML format to external devices via a network.

According to another aspect of the present invention an EPG information conversion method comprises extracting EPG information from a data stream; parsing the extracted EPG information, converting the parsed EPG information into an XML format, and transmitting the EPG information in the XML format to an external device across a network.

### BRIEF DESCRIPTION OF THE DRAWINGS

The above and/or other advantages of the present invention will become more apparent by describing in detail preferred embodiments thereof with reference to the attached drawings in which:

FIG. 1 is a block diagram of an electronic program guide (EPG) information converter according to an embodiment of the present invention;

FIG. 2 is a flowchart of an EPG information conversion method according to an embodiment of the present invention;

FIG. 3 is a diagram illustrating the structure of a program and service information protocol (PSIP) table for a ground-wave digital TV;

FIG. 4 is a diagram illustrating the structure of a virtual channel table (VCT) shown in FIG. 3;

FIG. 5 is a diagram illustrating the relationship between the VCT and an event information table (ETI) shown in FIG. 3; and

FIGS. 6A through 6D are examples of source codes in extensible markup language (XML) created by an XML converter shown in FIG. 1.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below to explain the present invention by referring to the figures.

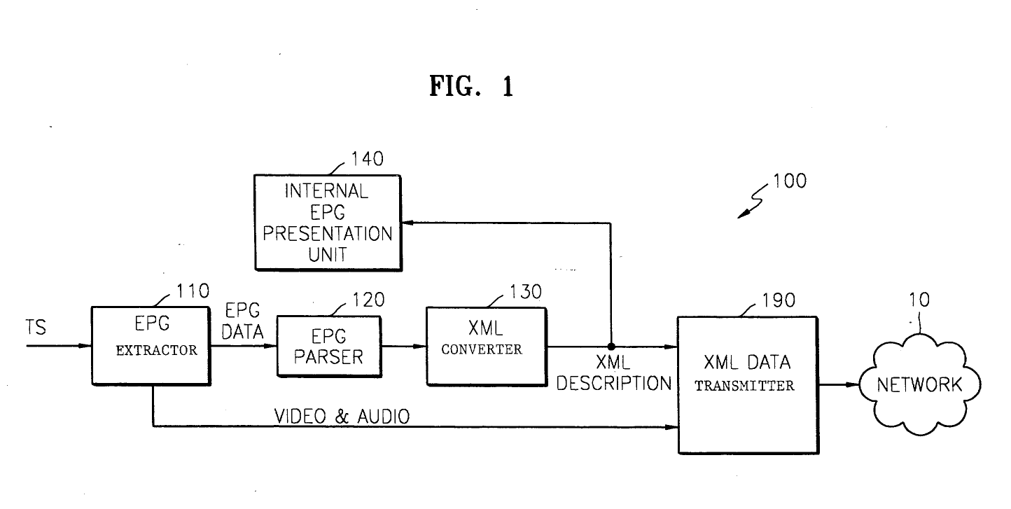

FIG. 1 is a block diagram of an electronic program guide (EPG) information converter 100 according to an embodiment of the present invention. Referring to FIG. 1, the EPG information converter 100 comprises an EPG extractor 110, an EPG parser 120, an extensible markup language (XML) converter 130, an internal EPG presentation unit 140, and an XML data transmitter 190.

The EPG extractor 110 is a demultiplexer that extracts data related to EPG information from a transport stream (TS). Here, typically, the TS is a data stream containing video and audio data as Packetized Elementary Streams (PESs) containing 184 bytes of payload data and a 4-byte header. The TS is also called motion picture experts group (MPEG) data.

The EPG parser 120 analyzes and interprets the EPG data input from the EPG extractor 110. The XML converter 130 converts information analyzed by the EPG parser 120 into extensible markup language (XML code). The XML data transmitter 190 transmits an output of the XML converter 30 to external devices via the network 10. The internal EPG presentation unit 140 internally displays the EPG data to a user using the XML output from the XML converter 130.

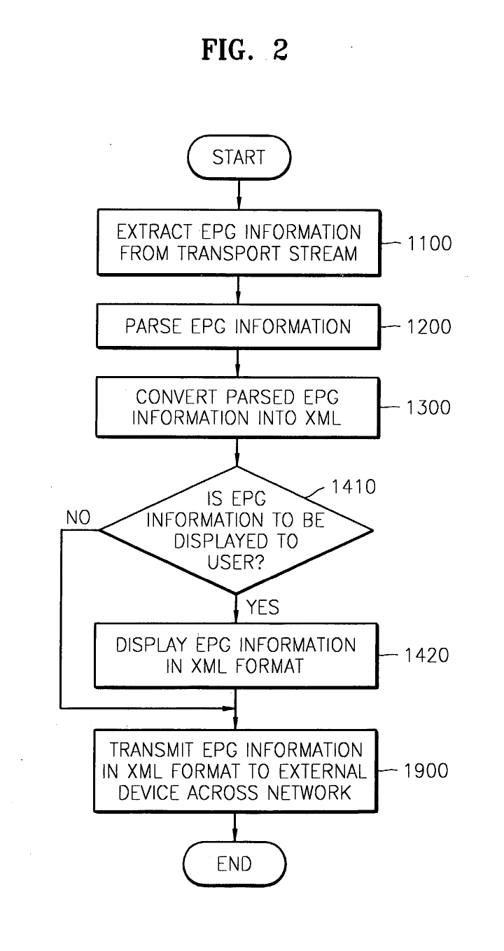

A method of converting EPG information, for ground-wave broadcasting, into an XML format and outputting the XML formatted EPG information will now be described with reference to FIGS. 1 and 2. FIG. 2 is a flowchart of an EPG conversion method according to an embodiment of the present invention. Referring to FIG. 2, at operation 1100, the EPG information converter 100 extracts EPG information from a TS using the EPG extractor 110. At operation 1200, the extracted EPG information is parsed using the EPG parser 120, and at operation 1300, information is selected from the parsed EPG information to be provided to a user, and the selected information is converted into an XML format, which specifies/describes what EPG information will be utilized, such as to be displayed to a user or exchanged with other receiving devices, for example, to control display or, otherwise, processes of the other receiving devices. Accordingly, the selected and XML formatted EPG information can be processed/analyzed by any receiving device processing markup language documents, such as XML, HyperText Markup Language (HTML), etc., to utilize the EPG information, thereby providing a standard EPG information exchange/parser specification to control devices receiving the EPG information, or a standard EPG information description describing EPG information usage. The present invention provides an apparatus and method of standardizing EPG information utilization (i.e., standard EPG information supply or interchange by or among receiving devices, such as what EPG information is provided to a user) by uniformly specifying/describing/organizing the EPG information. More particularly, the present invention provides an effective (uniform) analysis of the EPG information provided to or exchanged between network devices by analyzing received EPG information and converting important information contained in the EPG information into extensible markup language (XML). The EPG information described according to XML can uniformly control receiving devices by, for example, specifying/describing/instructing what content to display as well as how to display the content (presentation format) by, for example, binding/linking display elements (e.g., HTML display elements) to the content.

At operation 1410, whether the EPG information will be internally displayed to the user is checked. If, at operation 1410, it is determined to internally display the EPG information, at operation 1420, the EPG information in the XML format is displayed. At operation 1900, the EPG information in an XML format can be transmitted to other controllers connected to a network via the XML data transmitter 190.

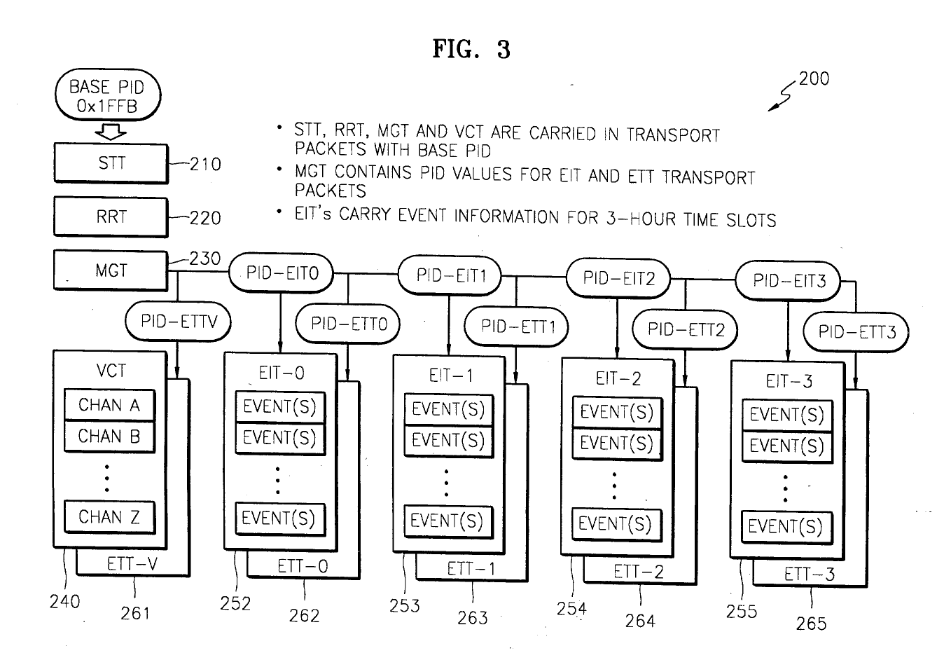

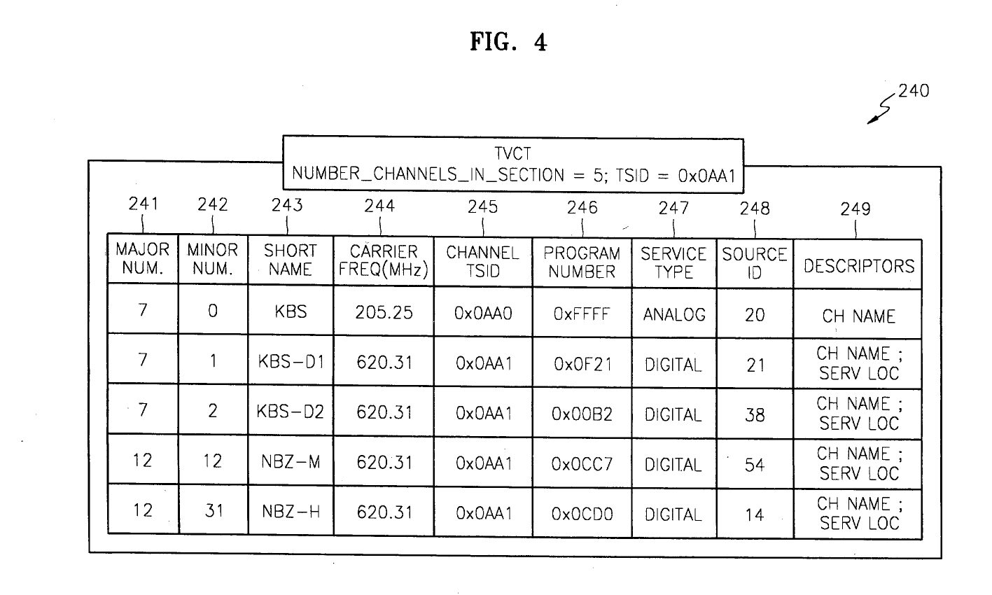

FIG. 3 is a diagram illustrating the structure of a program and service information protocol (PSIP) table 200 for a ground-wave digital TV. FIG. 4 is a diagram illustrating the structure of a virtual channel table (VCT) 240 shown in FIG. 3. Referring to FIG. 3, the PSIP table 200 comprises a system time table (STT) 210, a region rating table (RRT) 220, a master guide table (MGT) 230, the VCT 240, a plurality of event information tables (EITs) 252 to 255, and a plurality of event text tables (ETTs) 261 to 265.

The STT 210 holds various kinds of information related to the current time, and the RRT 220 holds information regarding a parental guideline for harmful TV programs. As shown in FIG. 4, the VCT 240 holds program information, such as program channel information 241, 242, and 243, carrier frequencies 244, program numbers 246, and service types 247. In FIG. 3, the ElTs 252 to 255 and the ETTs 261 to 265 hold information regarding plots, characters, the contents of a program, and so on. The MGT 230 holds information for checking an update state and a version of all of the tables shown in FIG. 3.

The information stored in the PSIP table 200 is largely divided into two parts: information to be displayed to a user of an EPG receiving device, such as a DTV, and information required within the receiving device. For instance, in FIG. 4, the major number 241, the minor number 242, and the short name 243 are information to be displayed to a user, and the other information 244 to 249 are required within the receiving device.

According to the present invention, through utilization of the features of the PSIP table 200, it is possible to provide user-related information to a device among devices that provide user interfaces and also possible to control external devices across the network 10. Therefore, information regarding contents of a program can be effectively provided to the user. More particularly, the EPG information converter 100 converts EPG information, which is to be displayed to the user, into an XML format, and the XML formatted documents can be exchanged with receiving devices to control the external devices, including display user interfaces of the external devices.

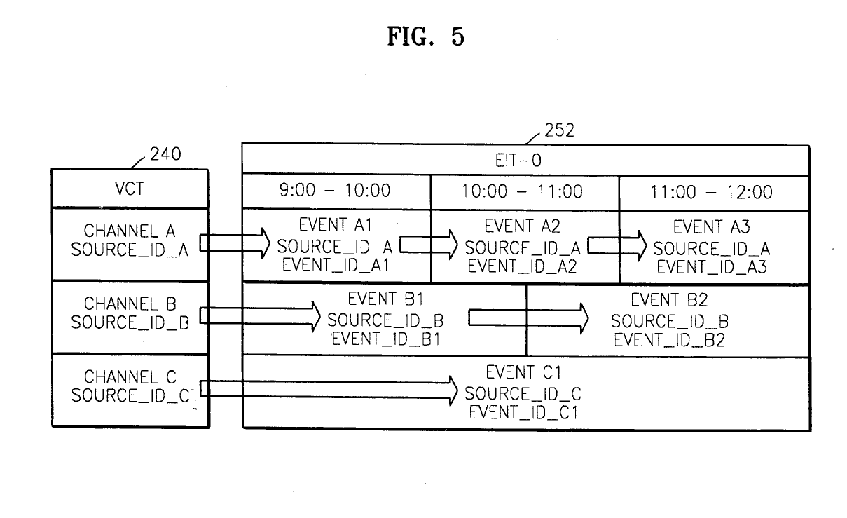

FIG. 5 is a diagram illustrating the relationship between the VCT 240 which holds information about programs and EIT 252, which holds contents of the programs shown in FIG. 3. From FIG. 5, it is noted that EPG information to be displayed to a user includes all information regarding a program to be broadcasted, as well as live broadcasts, according to the time zone. For this reason, there is a need to separately describe these two types of information, i.e., information regarding a live (currently) broadcast program and a program to be broadcasted, into XML data created by the EPG information converter 100.

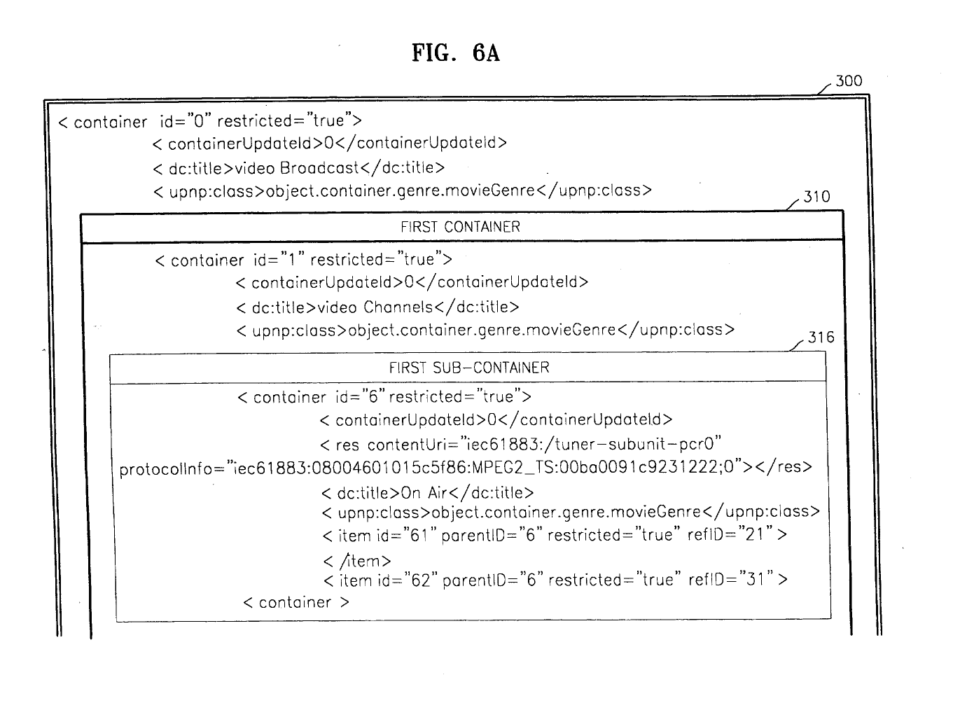

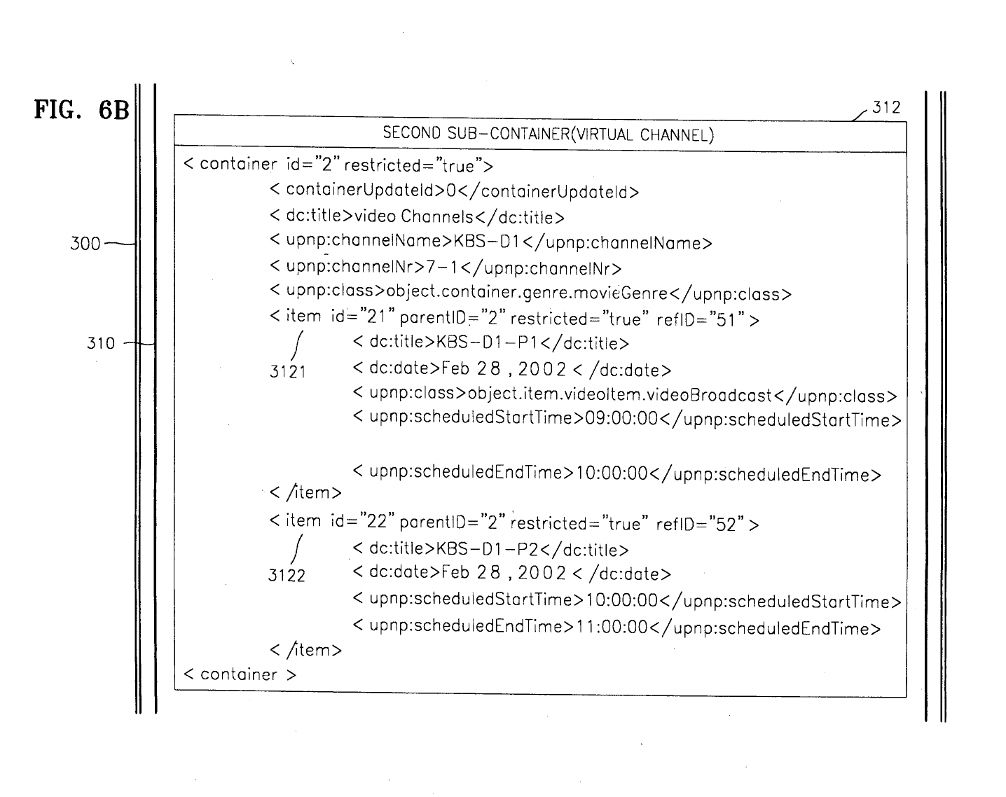

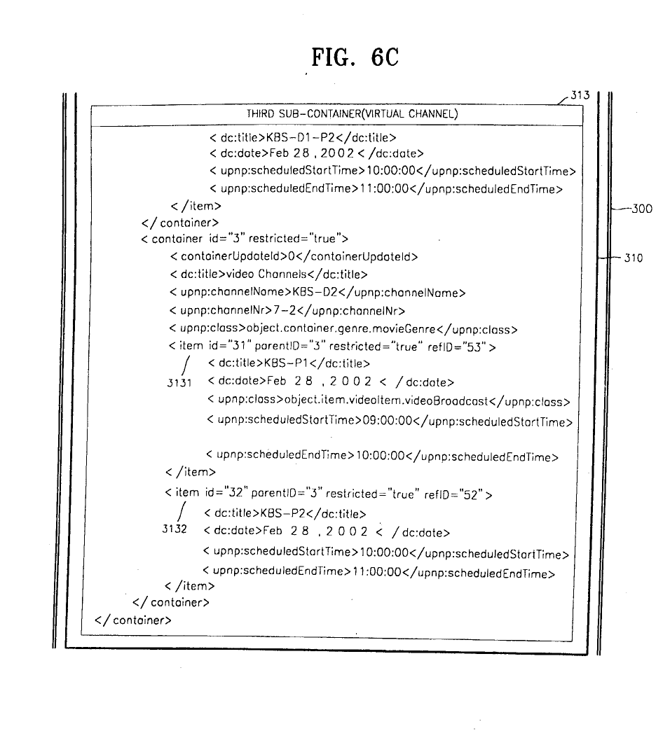

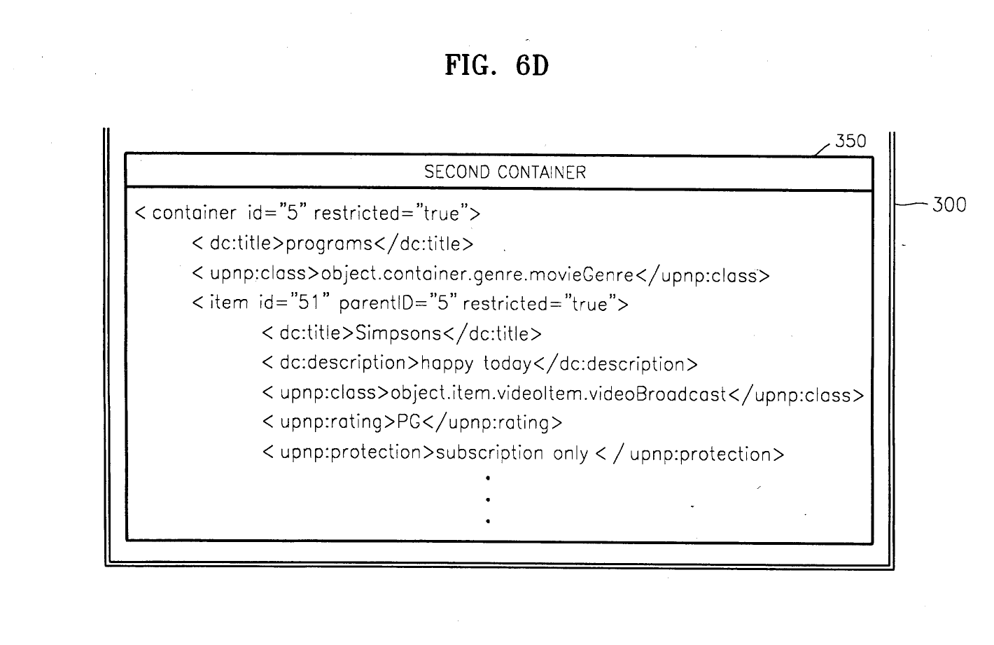

FIGS. 6A through 6D are example source codes in extensible markup language (XML) to describe the parsed EPG data, as created by the XML converter 130 shown in FIG. 1. Referring to FIGS. 6A through 6D, a top container 300, having container ID 0, is divided largely into two groups: a first container 310, having ID 1 (FIG. 6A) and contains time information of contents provided by the XML converter 130, and a second container 350, having ID 5 (FIG. 6D) and contains descriptions on the contents.

The first container 310 having time information is divided into a first sub-container 316 having ID 6 (FIG. 6A), and second and third sub-containers 312 and 313 having IDs 2 and 3, (FIGS. 6B, 6C) respectively, so as to separately describe information regarding a live (currently) broadcast program and programs to be broadcasted, as shown in FIG. 5. The first subcontainer 316 has physical resource information on the contents of a currently televised program, whereas the second and third sub-containers 312 and 313 have information regarding virtual channels of current and future events that are not being televised.

The second and third sub-containers 312 and 313, which present (describe) virtual channels, have a plurality of items of events of channels (refer to 3121, 3122, 3131, and 3132 of FIG. 6B and FIG. 6C). Each event channel in the sub-containers of the first container 310 is explained with a plurality of items in the second container 350 (id=5) and these items are searched for in the second container 350 with “refID,” i.e., reference to the items presented in the second and third sub-containers 312 and 313. For instance, the second container 350 (id=5) can hold descriptions on all of the contents irrespective of the kind of a virtual channel and describes contents referring to virtual channels. In the second container 350 (FIG. 6D), a reference to a virtual channel may be overlapped with other virtual channel references.

Further, each item of a sub-container that can currently provide content such as the first sub-container 316 (id=6), which comprises events currently being broadcasted, refers to items in other sub-containers, such as the second sub-container 312 (id=2), using “refID.” In particular, the first sub-container 316 (id=6) has a “res” tag to indicate that the first sub-container 316 (id=6) can provide contents at the present time (i.e., currently being broadcasted). Only a container having the “res” tag can provide contents. That is, a container having the “res” tag is one that televises broadcasts that are currently being received. Information regarding tags in the XML containers, including the “res” tag, is extracted from the VCT 240, the ElTs 252 to 255, the ETTs 261 to 265, and the RRT 220 and then formatted/represented/described according to XML (i.e., the extracted EPG information is organized as nested nodes/elements/objects providing data containers according to XML).

According to the present invention, a control or receiving device, such as a DTV, etc., to which EPG information is transmitted can have the EPG information converter 100 implemented therein to select and parse EPG information, which is converted into standard XML, and process the XML data, such as display the EPG information according to display designation conditions of the EPG information in the XML data (i.e., the EPG XML data can specify what information to be displayed as well as how the information is displayed). Further, only the EPG information to be displayed to a user can be sent to another control device as an XML document, thereby removing unnecessary information exchange for network control. Further, conversion of EPG information into XML can be performed with a variety of standardized parsers, such as a document object model (DOM) and sample API for XML (SAX), thereby providing a standard software development environment.

In the described embodiment, EPG information required by a digital TV is converted into an XML format. However, the present invention can be applied to various devices, such as a digital versatile disc (DVD) player, a cable set-top box, and a digital video cassette recorder (DCVR), all of which can be controlled by a network connection.

The present invention can be embodied as a computer readable code in a computer readable medium. Here, the computer readable medium may be any recording apparatus capable of storing data that can be read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave transmitting data via the Internet. The computer readable code can be dispersively installed in networked computer systems and executed by the distributed computing environment.

As described above, using an apparatus and method of converting electronic program guide (EPG) information according to the present invention, it is possible to convert important information contained in EPG information into extensible markup language (XML) and provide the XML documents to other externally controlled devices via a network or to display the EPG information of the XML documents for a user according to display designations of the EPG information in the XML document. Accordingly, the EPG information between devices connected to network can be effectively parsed and utilized. More particularly, the present invention can provide an EPG information display definition (i.e., a display designation standard) using XML. In the present invention EPG information is extracted from a data stream, the extracted EPG information is converted into an XML format, and the EPG information is displayed to a user if the EPG information in the XML data is designated as user displayable. Further, the present invention provides an EPG information exchange standard by transmitting the EPG information in the XML format to other external devices to control such external devices. Although the example embodiment uses XML to define displayable EPG information, the present invention is not limited to such configuration and the present invention may be implemented using other markup languages that provide rules of defining and interpreting tags for data transmission, including data exchange markup languages other than XML and according to the Standard Generalized Markup Language (SGML) rules. Accordingly, devices that implements software/hardware to interpret markup language documents to control the device, such as to format and display data, including multimedia data, to communicate data, to organize data, etc., can uniformly operate in response to a data-exchange markup language document describing/organizing EPG information.

While this invention has been particularly shown and described with reference to preferred embodiments thereof, it will be understood by those skilled in the art that various changes in form and details may be made therein without departing from the spirit and scope of the invention as defined by the appended claims and their equivalents.

What is claimed is:

1. An electronic program guide (EPG) information converter in a device, comprising:
an EPG extractor extracting EPG information from a data stream;
an EPG parser parsing the extracted EPG information;
an extensible markup language (XML) converter converting the parsed EPG information into an XML format;
an internal EPG presentation unit presenting program information to a user in response to the EPG information in the XML format; and
an XML data transmitter transmitting the EPG information in the XML format to external devices via a network.

2. The converter of claim 1, wherein the EPG information is divided into information to be displayed to the user and information required within the device.

3. The converter of claim 2, wherein the XML converter converts the information to be displayed to the user into the XML format.

4. The converter of claim 1, wherein the EPG information in the XML format comprises:
a first container comprising time information regarding contents provided by the device; and
a second container including descriptions on the contents provided by the device.

5. The converter of claim 4, wherein the first container comprises:
a first sub-container holding physical resource information regarding contents currently being broadcast; and
at least one second sub-container representing virtual channels that include current and future events that are not currently being broadcast.

6. The converter of claim 5, wherein the first sub-container refers to the second sub-container through reference information.

7. The converter of claim 5, wherein the second container comprises all of the descriptions of the contents related to the first and the at least one second sub-container.

8. An EPG information conversion method comprising:
extracting EPG information from a data stream;
parsing the extracted EPG information;
converting the parsed EPG information into an XML format; and
transmitting the EPG information in an XML format to an external device across a network.

9. The method of claim 8 further comprising displaying the EPG information in an XML format to a user of the device.

10. The method of claim 8, wherein the EPG information comprises information to be displayed to a user and information required within the device, and the information to be displayed to a user is converted into the XML format.

11. The method of claim 8, wherein the EPG information in the XML format comprises:
a first container comprising time information regarding contents provided by the device; and
a second container including descriptions on the contents provided by the device.

12. The method of claim 11, wherein the first container comprises:
a first sub-container holding physical resource information regarding contents that are currently being broadcasted; and
at least one second sub-container representing virtual channels that include current and future events that are not currently broadcasted.

13. The method of claim 12, wherein the first sub-container refers to the second sub-container through reference information.

14. The method of claim 12, wherein the second container comprises all of the descriptions of the contents of the first and the at least one second sub-container.

15. A computer-readable recording medium recording a program to control a computer and comprising a process of:
extracting EPG information from a data stream;
parsing the extracted EPG information;
converting the parsed EPG information into an XML format; and
transmitting the EPG information in the XML format to an external device across a network.

16. A method of utilizing EPG information, comprising:
extracting EPG information from a data stream;
generating a data-exchange markup language document based upon the extracted EPG information; and
utilizing the EPG information according to the generated markup language document.

17. The method of claim 16, wherein the utilization of the EPG information comprises displaying the EPG information.

18. The method of claim 17, wherein the utilization further comprises transmitting the generated markup language document.

19. An electronic program guide (EPG) information converter in a device, comprising:
an EPG extractor extracting EPG information from a data stream;
a generator generating a data-exchange markup language document by describing the extracted EPG information according to a data-exchange markup language; and
processing units utilizing the EPG information according to the generated markup language document.

20. The converter of claim 19, wherein the generator parses the extracted EPG information and generates an extensible markup language (XML) document by describing the parsed EPG information according to the XML.

21. The converter of claim 19, wherein the processing units display the EPG information and/or transmit the EPG information to external devices via a network, according to the generated XML document.
